(19) United States
(12) Patent Application Publication
(10) Pub. No.: US 2005/0102888 A1
(43) Pub. Date: May 19, 2005

(54) Insect trap

(76) Inventors: Charles Kenneth Curnow, Cannonvale (AU); Bryan Kenneth Curnow, Kynuna (AU); Tanya Vellacott, Toowoomba (AU)

Correspondence Address: LAURA G. BARROW, P.O. BOX 215, ESTERO, FL, 33928, US

(21) Appl. No.: 10/479,548

(22) PCT Filed: Jun. 3, 2002
(86) PCT No.: PCT/AU02/00699

(30) Foreign Application Priority Data
Jun. 4, 2001 (AU) PR 5407

(51) Int. Cl. A01M 1/04

(52) U.S. Cl. 43/113

(57) ABSTRACT

A trap (1) is described which is substantially cylindrical in shape having a base (2), side wall (3) and a removable upper portion (4) which has an upper surface (7) substantially concave in shape. An open-topped mesh basket (6) rests on a mesh (5) support within the trap (1). A light (14) is positioned just above the upper surface (7) of the upper portion (4) which, when energized, attracts the insect to be exterminated. The trap (1) is approximately two thirds filled with water (16) which is then pumped from within the body of the trap to create a substantially helical flow of liquid over the upper surface (7) of the upper portion (4) as it returns to the body of the trap (1). Insects attracted to the light (14) are entrained by the water (16) and are flushed down into the trap and retained within the mesh basket (6). As an alternative, the upper surface (7) can be substantially convex in shape and the water flows substantially radially over the upper surface (7) of the upper portion (4).

THIS INVENTION relates to an insect trap. In particular, but in no way limiting, it is directed to a trap to ensnare flying insects such as flies, mosquitos, aphids, midges and moths.

Notwithstanding any beneficial role in the overall natural food chain that they may offer, some insects are often classified as pests by humans. The unwanted traits of such pests can range simply from being an irritation by flying close around humans as the humans are, for example, having a meal outdoors, to eating or otherwise damaging crops designated for human consumption.

With special reference to crop farming, heliathes moths do considerable damage to cotton crops. Significant costs are incurred by a cotton farmer annually to eradicate or at least control these moths.

Typically, control of unwanted pests such as the heliathes moth is by the use of chemical sprays. However, significant adverse issues, predominantly health-related, are now evident following the increasing extensive use of such sprays. These issues include contamination of food crops, human disorders such as cancer and other serious diseases following exposure to the sprays, and conflict between cotton growers and graziers when traces of insecticide are discovered in meat-producing animals which are thus subsequently excluded from sales.

Further, as increasing quantities of insecticides are used, the caterpillars or grubs from which moths evolve are becoming more resistant to the insecticides which leads to ever-increasing powerful formulations which merely increase the problems identified above with respect to their use. Also, birds, which are the usual natural predators of caterpillars and grubs, are being adversely affected by ingesting these increasingly powerful chemicals.

This over utilization of toxic insecticides has lead to the development of devices which use the less-hazardous naturally-occurring chemicals or non-chemical methods to attract and exterminate unwanted insects.

There are a variety of such prior art devices, particularly to attract and or exterminate flying insects such as flies, mosquitos, aphids, midges and moths.

One such type employs light to attract insects. Once attracted to the device by the light, the insects are exterminated by various means. A popular device is the readily available unit which utilizes ultraviolet light to attract the insect which is then electrocuted on contact with the light source.

While this type of device is suited for relatively confined areas such as a building or balcony of a building, they are not particularly suitable or practical for use in a large open area such as a crop field.

Another type of prior art trap emits a chemical attractant derived from the very insect to be exterminated. However, although direct contact of a chemical with humans or food is somewhat reduced, a safety concern remains as nearby humans and animals may still inhale a potentially toxic formulation.

It is thus a general object of the present invention to overcome, or at least ameliorate, one or more of the above disadvantages.

According to a first aspect of the present invention, there is provided a trap to attract and ensnare a flying insect such as a fly, mosquito, aphid, midge, moth or similar, said trap including:
a container adapted to hold liquid, said container having a base, a curved upper portion substantially opposed to said base, and a side wall connecting said base land said upper portion;
means to recirculate said liquid held in said container from at or near said base over an upper surface of said upper portion; and
an attractant for said insect positioned at or near said upper surface of said upper portion;
wherein said means to recirculate said liquid and said upper portion are adapted to allow said liquid to flow in a specific path over said upper surface.

Preferably, said liquid is water.

Preferably, said trap also includes a mesh-like material removably positioned within said container and adapted to allow said liquid to pass through while preventing any said insect that may be within said container from passing through.

Preferably, said attractant is positioned above said upper surface of said upper portion.

Preferably, said attractant is a light source.

Preferably, said light source emits radiation at a wavelength which attracts a specific said insect.

Preferably, said insect is a moth.

Preferably, said moth is a heliathes moth.

In one embodiment of the present invention, said means to recirculate said liquid and said upper portion are adapted to allow said liquid to flow in a substantially helical path over said upper surface.

In this one embodiment, said upper surface is substantially concave in shape.

In a second embodiment of the present invention, said means to recirculate said liquid and said upper portion are adapted to allow said liquid to flow radially over said upper surface.

In this second embodiment, said upper surface is substantially convex in shape.

As a second aspect of the present invention, there is provided a method of attracting and exterminating an insect such as a fly, mosquito, aphid, midge, moth or similar, said method including the use of a trap as hereinbefore described.

Preferred embodiments of the present invention will now be described with reference to the accompanying drawings wherein:

FIG. 1 is a schematic perspective sketch of a first embodiment of a trap constructed in accordance with the present invention;

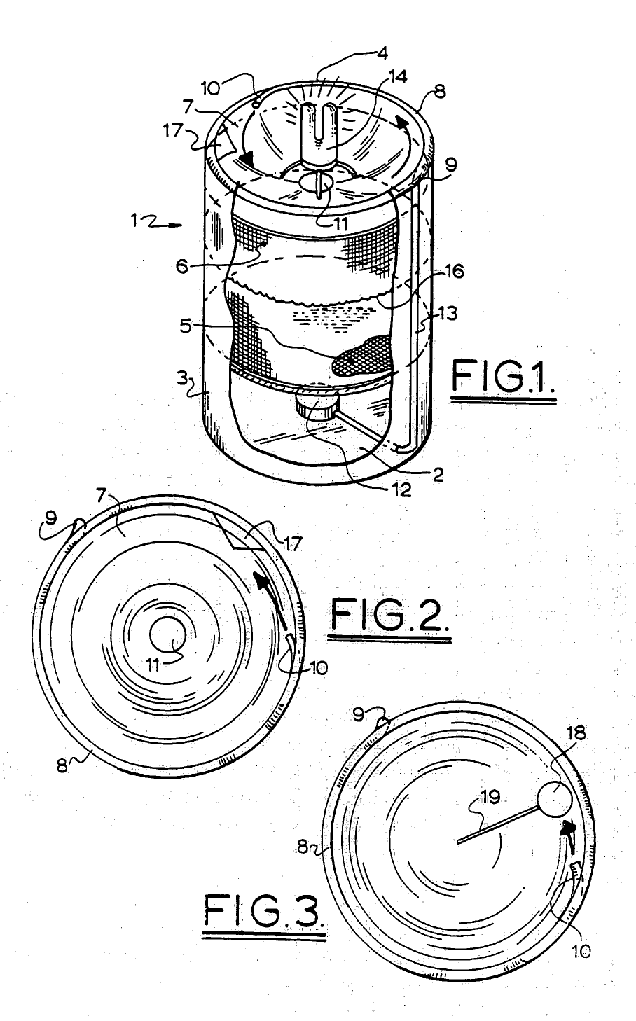

FIG. 2 is a top plan view of the first embodiment illustrated in FIG. 1;

FIG. 3 is a top plan view of a second embodiment of a trap constructed in accordance with the present invention;

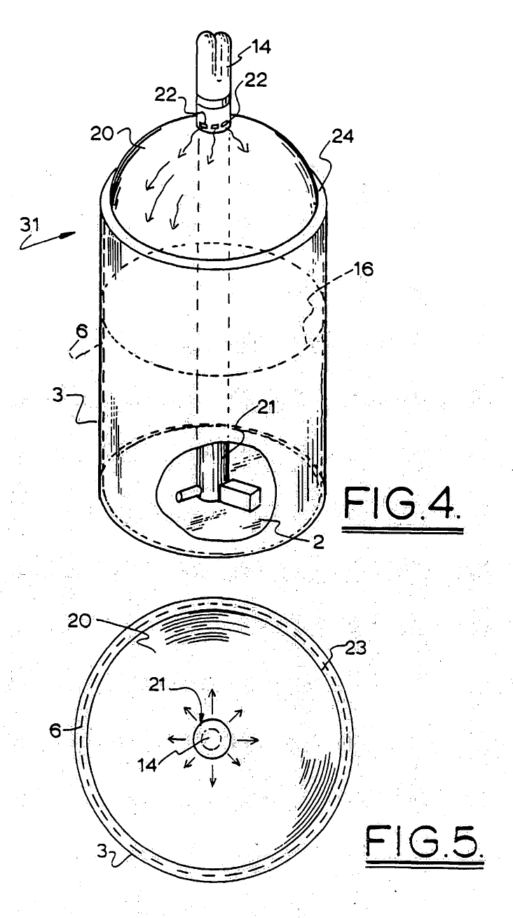

FIG. 4 is a schematic perspective sketch of a third embodiment of a trap constructed in accordance with the present invention; and

FIG. 5 is a top plan view of the third embodiment illustrated in FIG. 4.

With reference to FIGS. 1 and 2, the trap (1) is substantially cylindrical in shape having a base (2), side wall (3) and a removable upper portion (4). A first mesh (5) is affixed within the trap (1) a short distance from the base (2). An open-topped substantially cylindrical mesh basket (6) rests on the mesh (5). The upper portion (4) has an upper surface (7) which is substantially concave in shape. A conduit (8) extends partway around the perimeter of the upper portion (4) having an inlet (9) and terminating in an outlet (10). The outlet (10) is positioned to allow exiting liquid to flow down the upper surface (7) and pass through an orifice (11) at the lowest point of the upper portion (4) returning the liquid to the body of the trap (1). A cutout portion (17) is positioned near the perimeter of the upper portion (4). A submersible pump (12) is positioned on the base (2) and is connected to the inlet (9) by a flexible hose (13). A light (14) is positioned just above the upper surface (7) of the upper portion (4).

Although the first mesh (5) and mesh basket (6) have been described above as separate items, it will be appreciated by those skilled in the art that the first mesh (5) could form the base of the mesh basket (6) and the thus integral unit be adapted to be supported on the upper edge of the side wall (3) under the removable upper portion (4).

In use, the trap (1) is approximately two thirds filled with water (16). On application of power to the pump (12), water (16) is pumped from near the base (2) through the flexible hose (13) into the inlet (9) land out of the outlet (10) to fill the concave cavity of the upper portion. Excess water (16) is returned to the body of the trap (1) through the cutout (17). The water (16) is pumped at sufficient pressure to create; a substantially helical flow of liquid over the upper surface (7) of the upper portion (4) as it returns to the body of the trap (1) through the orifice (11). Application of power also energizes the light (14). This application of the power can be by any convenient means known in the art, but a particularly preferred option is to include a photo-electric cell in the electrical circuit which initiates power at a low level of light, e.g. at sundown, and which is disengaged at a greater level of light, e.g. at sunrise. Alternatively, disengagement of the power can be undertaken by the incorporation of a timer into the electrical circuit. Once the trap (1) is activated, insects attracted to the light (14) are entrained by the water (16) and are flushed down through the orifice (11) and are retained within the mesh basket (6). Periodically, the upper portion (4) can be removed which, in turn, allows the mesh basket (6) to be removed to enable the ensnared insects to be removed.

As illustrated in FIG. 3, in an alternative embodiment, the upper portion (4) can be modified by placing an orifice (18) closer to the perimeter of the upper portion (4) and having a baffle (19) positioned spaced above the upper surface (7) and extending from the orifice (18) towards the centre of the upper portion (4). Operation of the trap (1) is similar as described above with reference to FIGS. 1 and 2 but with the helical flow of water (16) passing under the baffle (19) and any insects on the surface of the water (16) being skimmed off by the baffle (19) and flushed down the orifice (18).

In a third embodiment as depicted in FIGS. 4 and 5, the trap (31) has the base (2), side wall (3), mesh basket (6), pump (12) and light (14) as described with reference to FIGS. 1 to 3. However, the upper portion (24) has a light-reflective convex upper surface (20). The perimeter of the upper portion (24) terminates a short distance before the mesh basket (6) to create a perimeter gap (23). A hollow tubular member (21) extends from the base (2) and upwards through the upper surface (20). Slits (22) are in the tubular member (21) positioned radially around the circumference of the tubular member (21) and just above the upper surface (20).

In use, the trap (31) is filled approximately three quarters with water (16). On application of power to the pump (12), water (16) is pumped from near the base (2) upwards through the tubular member (21), out through the slits (22) to flow substantially radially over the upper surface (20) and returned to the body of the trap (31) through the perimeter gap (23). Once again, application of power also energises the light (14), the reflective nature of the upper surface (20) enhancing the light emission and assisting in attracting an insect to the light (14). After the trap (31) is activated, insects attracted to the light (14) are entrained by the water (16) and fare flushed down over the surface (20) and through the perimeter gap (23) to be retained within the mesh basket (6). Periodically, the upper portion (24) can be removed which, in turn, allows the mesh basket (6) to be removed to enable the ensnared insects to be removed.

The present invention thus provides a relatively simple, inexpensive to manufacture and operate and non-chemical trap for flying insects.

It will be appreciated that the above embodiments are exemplification of the present invention only and that modifications and alterations can be made without departing from the inventive concept as defined in the following claims.

1. A trap to attract and ensnare a flying insect such as a fly, mosquito, aphid, midge, moth or similar, said trap including:
a container adapted to hold liquid, said container having a base, a curved upper portion substantially opposed to said base, and a side wall connecting said base and said upper portion;
means to recirculate said liquid held in said container from at or near said base over an upper surface of said upper portion; and
an attractant for said insect positioned at or near said upper surface of said upper portion;
wherein said means to recirculate said liquid and said upper portion are adapted to allow said liquid to flow in a specific path over said upper surface.

2. A trap as defined in claim 1 wherein said liquid is water.

3. A trap as defined in claim 1 which further includes a mesh-like material removably positioned within said container and adapted to allow said liquid to pass through while preventing any said insect that may be within said container from passing through.

4. A trap as defined in claim 1 wherein said attractant is positioned above said upper surface of said upper portion.

5. A trap as defined in claim 1 wherein said attractant is a light source.

6. A trap as defined in claim 5 wherein said light source emits radiation at a wavelength which attracts a specific said insect.

7. A trap as defined in claim 1 wherein said insect is a moth.

8. A trap as defined in claim 7 wherein said moth is a heliathes moth.

9. A trap as defined in claim 1 wherein said means to recirculate said liquid and said portion upper portion are adapted to allow said liquid to flow in a substantially helical path over said upper surface.

10. A trap as defined in claim 9 wherein said upper surface is substantially concave in shape.

11. A trap as defined in claim 1 wherein said means to recirculate said liquid and said upper portion are adapted to allow said liquid to flow radially over said upper surface.

12. A trap as defined in claim 11 wherein said upper surface is substantially convex in shape.

13. A method of attracting and exterminating an insect selected from the group of a fly, mosquito, aphid, midge, moth or similar, said method including the use of a trap as defined claim 1.
